(19) United States
(12) Patent Application Publication
(10) Pub. No.: US 2013/0228518 A1
(43) Pub. Date: Sep. 5, 2013

(54) SEPARATION MEMBRANE MODULE AND FLUID SEPARATION METHOD

(71) Applicants: Kenichi ITO, Kirishima-shi (JP); Masaaki OBATA, Kirishima-shi (JP)

(72) Inventors: Kenichi ITO, Kirishima-shi (JP); Masaaki OBATA, Kirishima-shi (JP)

(73) Assignee: KYOCERA Corporation, Kyoto (JP)

(21) Appl. No.: 13/512,208

(22) Filed: May 25, 2012

Related U.S. Application Data
(63) Continuation-in-part of application No. PCT/JP2010/071098, filed on Nov. 26, 2010.

(30) Foreign Application Priority Data
Nov. 27, 2009 (JP) 2009-269455
Nov. 27, 2009 (JP) 2009-269621

(51) Int. Cl. B01D 63/06

(52) U.S. Cl. CPC B01D 63/06
USPC 210/650; 210/321.87; 210/196

(57) ABSTRACT

A separation membrane module and fluid separation method are disclosed. A plurality of tubes are arranged in a body. A first chamber on a first fixed plate at an opposite side where the tubes are attached, comprising a plurality of rooms divided by at least one divider. A second chamber on a second fixed plate at an opposite side where the tubes are attached, comprising a plurality of rooms divided by at least one divider. The tubes are connected in series in terms of fluid path. A operation in which mixed fluid containing two or more types of fluid that flows into one of the rooms within one of chambers flows within one of the tubes, flows into one of the rooms within another chamber, and flows into another of the tubes by way of one of the rooms within the another chamber is repeatedly carried out.

### CROSS-REFERENCE TO RELATED APPLICATION

The present application is a continuation in part of PCT Application No. PCT/JP2010/071098, filed on Nov. 26, 2010, and claims the benefit of Japanese Application No. 2009-269621, filed on Nov. 27, 2009, and Japanese Application No. 2009-269455, filed on Nov. 27, 2009. PCT Application No. PCT/JP2010/071098 is entitled “SEPARATION MEMBRANE MODULE AND FLUID SEPARATION METHOD”, and both Japanese Application No. 2009-269621 and No. 2009-269455 are entitled “SEPARATION MEMBRANE MODULE”. The above applications are incorporated by reference herein in their entirety.

### FIELD

Embodiments of the present disclosure generally relate to separation membrane modules, and more particularly relate to a separation membrane module separating mixed fluid into at least two fluids.

### BACKGROUND

As conventional separation membrane module, a separation membrane module has been known which has heating chambers arranged at U-shaped connecting pipes that connect separation-membrane-equipped tubes in series fashion at either side of a cylindrical housing that retains the separation-membrane-equipped tubes.

However, with the above separation membrane module, there have been problems in that, because ends of separation-membrane-equipped tube (tubular membrane) segments within the cylindrical housing must be joined using U-shaped connecting pipes which are pipes bent in the shape of a U, configuration may be made complicated, and there may be many manufacturing operations; and because procedures must be carried out by hand, manufacturing may be made troublesome.

### SUMMARY

A separation membrane module and fluid separation method are disclosed. A plurality of tubes are arranged in a body. A first chamber on a first fixed plate at an opposite side where the tubes are attached, comprising a plurality of rooms divided by at least one divider. A second chamber on a second fixed plate at an opposite side where the tubes are attached, comprising a plurality of rooms divided by at least one divider. The tubes are connected in series in terms of fluid path. An operation in which mixed fluid containing two or more types of fluid that flows into one of the rooms within one of the chambers flows within one of the tubes, flows into one of the rooms within another chamber, and flows into another of the tubes by way of one of the rooms within the another chamber is repeatedly carried out.

In an embodiment, a separation membrane module comprises: a body, a first chamber, a second chamber. The body comprises a first fixed plate, a second fixed plate, and a plurality of tubes arranged with prescribed spacing, each tube comprising a separation membrane therein, wherein a first end of the tubes are attached to the first fixed plate, and a second end of the tubes are attached to the second fixed plate. The first chamber on the first fixed plate at an opposite side where the tubes are attached, comprising a plurality of rooms divided by at least one divider. The second chamber on the second fixed plate at an opposite side where the tubes are attached, comprising a plurality of rooms divided by at least one divider. Further, the tubes are connected in series in terms of fluid path.

In another embodiment, a separation membrane module comprises a sensor. The sensor measures concentration of a chemical in fluid flowing within the tubes.

In a further embodiment, a separation membrane module comprises a swirling-flow inducer. The swirling-flow inducer is provided at a location which is upstream of at least one of the tubes induces swirling flow in a fluid within the tubes.

In a further embodiment, a separation membrane module comprises a fluid inlet, a fluid outlet, on-off valves, and a circulation passage. The fluid inlet through which the fluid flows into the first chamber. The fluid outlet through which the fluid flowing within the separation-membrane-equipped tubes flows out of the first chamber. The on-off valves respectively provided at the fluid inlet and the fluid outlet. Further, the circulation passage that causes the fluid flowing out of the fluid outlet to be returned to the fluid inlet when the on-off valves are in their closed states.

In further embodiment, fluid separation method for a separation membrane module, repeatedly carry out a first operation in which mixed fluid containing two or more types of fluid that flows into one of rooms within one of chambers flows within one of tubes, a second operation in which the mixed fluid flowing within one of the tubes flows into one of the rooms within another chamber, and a third operation in which the mixed fluid flowing within one of the rooms in the another chamber flows into another of the tubes by way of one of the rooms within the another chamber. The method also flows the mixed fluid sequentially through interiors of the plurality of tubes. The method also passes at least one type of fluid comprised in the mixed fluid within the tubes through the separation membranes. The method also flows another fluid comprised in the mixed fluid through interiors of the tubes. The method further separates the mixed fluid into at least two fluids.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1A is an exploded perspective view in accordance with an embodiment of the disclosure.

FIG. 1B is an explanatory diagram showing flow of mixed fluid within the chamber at the left side at FIG. 1A.

FIG. 1C is an explanatory diagram showing flow of mixed fluid within the chamber at the right side at FIG. 1A.

FIG. 2A is a partial sectional view of the separation-membrane-equipped tube.

FIG. 2B is an enlarged sectional view of a portion of FIG. 2A.

FIG. 3A is an exploded perspective view in accordance with an embodiment of the disclosure.

FIG. 3B is an explanatory diagram showing flow of mixed fluid within the chamber at the left side at FIG. 3A.

FIG. 3C is an explanatory diagram showing flow of mixed fluid within the chamber at the right side at FIG. 3A.

FIG. 4A is an exploded view of a separation membrane module having six separation-membrane-equipped tubes in accordance with an embodiment of the disclosure.

FIG. 4B is an explanatory diagram showing flow of mixed fluid within the chamber at the left side of FIG. 4A.

FIG. 4C is an explanatory diagram showing flow of mixed fluid within the chamber at the right side of FIG. 4A.

FIG. 5 is an exploded view of a separation membrane module having twelve separation-membrane-equipped tubes.

FIG. 6A is an exploded view in accordance with an embodiment of the disclosure.

FIG. 6B is a perspective view showing how the chamber at the left side would appear when viewed from the left side of FIG. 6A.

FIG. 6C is a perspective view showing how the chamber at the right side would appear when viewed from the right side of FIG. 6A.

FIG. 7A is a sectional view showing the situation that plate-like members have swirling-flow inducers at through-holes.

FIG. 7B is a plane view of FIG. 7A as seen from the left side.

FIG. 7C is an explanatory diagram showing flow of mixed fluid within a separation-membrane-equipped tube.

FIG. 8A is an exploded perspective view in accordance with an embodiment of the disclosure.

FIG. 8B is an explanatory diagram showing flow of mixed fluid within the chamber at the left side at FIG. 8A.

FIG. 8C being an explanatory diagram showing flow of mixed fluid within the chamber at the right side at FIG. 8A.

FIG. 9 is a sectional view showing a separation membrane module in which swirling-flow inducers are provided at fixed plates.

FIG. 10A being an exploded view in accordance with an embodiment of the disclosure.

FIG. 10B is an explanatory diagram showing flow of mixed fluid within the chamber at the left side at FIG. 10A.

FIG. 10C is an explanatory diagram showing flow of mixed fluid within the chamber at the right side at FIG. 10A.

FIG. 10D is an explanatory diagram showing the interior of the chamber at the left side at FIG. 10A at which swirling-flow inducers are provided.

FIG. 10E is an explanatory diagram showing the interior of the chamber at the right side at FIG. 10A at which swirling-flow inducers are provided.

FIG. 11 is an explanatory diagram of a separation membrane module which has rod heaters within separation-membrane-equipped tubes.

FIG. 12 is an explanatory diagram of a separation membrane module which has heating devices for heating fluid within chambers.

FIG. 13A being an exploded perspective view in accordance with an embodiment of the disclosure.

FIG. 13B being an explanatory diagram showing flow of mixed fluid within the chamber at the left side at FIG. 13A.

FIG. 13C is an explanatory diagram showing flow of mixed fluid within the chamber at the right side at FIG. 13A.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application. Embodiments of the disclosure, however, are not limited to such separation membrane module, and the techniques described herein may be utilized in other applications.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

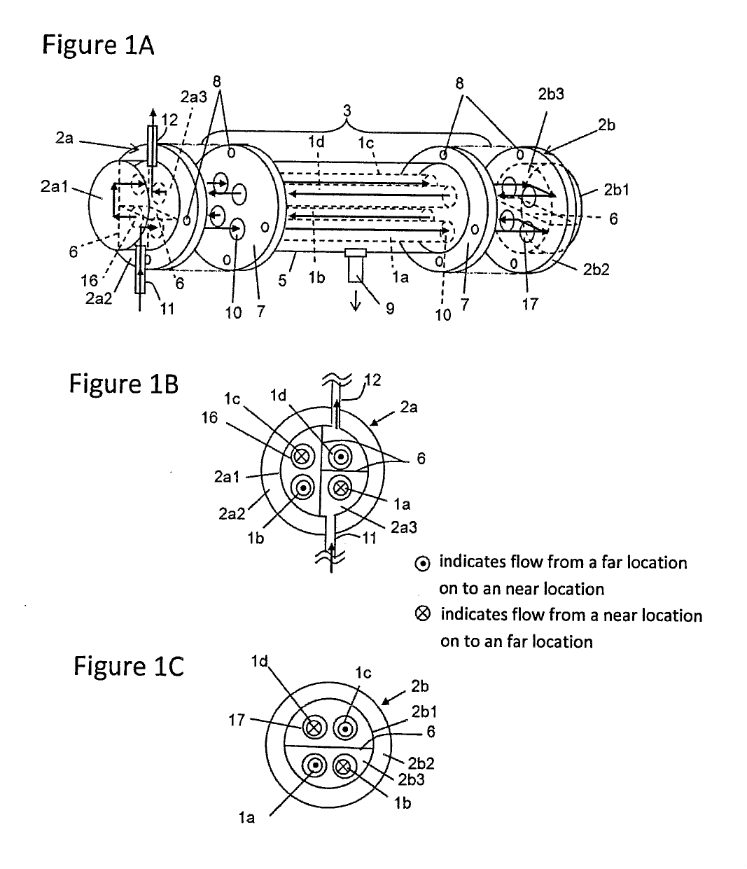

A separation membrane module in accordance with an embodiment will be described with reference to FIG. 1. FIG. 1A shows an exploded perspective view of a separation membrane module, the separation membrane module having four cylindrical tubes 1 that are open at either end and that are equipped with separation membranes.

These four separation-membrane-equipped tubes 1 are arranged in parallel fashion with prescribed spacing between side faces thereof, the two ends of each of the four separation-membrane-equipped tubes 1 being respectively attached to fixed plates 7. Moreover, the four separation-membrane-equipped tubes 1 are comprised within cylindrical housing 5, the two ends of this housing 5 also being respectively attached to fixed plates 7. Module body 3 comprises separation-membrane-equipped tubes 1, housing 5, and fixed plates 7.

Note that whereas cylindrical separation-membrane-equipped tubes 1 have been employed at FIG. 1, these need not be cylindrical, but may, for example, be of rectangular cross-section. Furthermore, whereas housing 5 is shown as cylindrical in FIG. 1, this need not be cylindrical, but may, for example, be cylinder-like but have rectangular cross-section.

The two ends of each of the separation-membrane-equipped tubes 1 are attached to the fixed plates in such fashion as to respectively be inserted within insertion holes 10 in the fixed plates 7. With regard to the material employed for fixed plates 7, while there is no particular limitation with respect thereto so long as this is such as to permit attachment of separation-membrane-equipped tubes 1 to fixed plates 7 without leakage of mixed fluid (hereinafter sometimes referred to simply as “fluid”), employment, for example, of components made from rubber therefor will permit reduction in stresses produced during attachment of separation-membrane-equipped tubes 1.

Fixed plates 7 of module body 3 are respectively provided with chambers 2a, 2b (hereinafter sometimes referred to simply as “chambers 2”), divider 6 being provided within chambers 2a, 2b so as to control flow of fluid such that it flows in series fashion within the plurality of separation-membrane-equipped tubes 1. In other words, the interiors of chambers 2a, 2b are divided into a plurality of compartments by divider 6, and the plurality of separation-membrane-equipped tubes 1 are connected in series fashion by way of the compartments into which the interiors of chambers 2a, 2b have been divided by divider 6, and mixed fluid is controlled so as to pass through separation-membrane-equipped tubes 1 in sequential (series) fashion.

Chambers 2a, 2b have chamber-forming portions 2a1, 2b1 and have flanges 2a2, 2b2 which are provided at the chamber-forming portions 2a1, 2b1, chamber-forming portions 2a1, 2b1 and fixed plates 7 being securely attached to each other by aligning insertion holes 8 in the outer peripheral portions of flanges 2a2, 2b2 of chambers 2a, 2b with insertion holes 8 in the outer peripheral portions of fixed plates 7, and while in this state, causing bolts inserted within insertion holes 8 to be tightened. Note that whereas tightening of bolts was employed as the method of attaching flanges 2a2, 2b2 and fixed plates 7 to each other in FIG. 1A, attachment may also be carried out through use of metal fasteners or the like. Hereinafter, chamber-forming portion 2a1 is referred to as “chamber body 2a1”, and chamber-forming portion 2b1 is referred to as “chamber body 2b1”.

Divider 6 provided within chamber body 2a1 at the left side of module body 3 divides the interior of chamber body 2a1 into three compartments, and divider 6 provided within chamber body 2b1 at the right side of module body 3 divides the interior of chamber body 2b1 into two compartments. Separation-membrane-equipped tubes 1 communicate with the respective compartments of chamber bodies 2a1, 2b1.

That is, divider 6 is attached to and housed within chamber bodies 2a1, 2b1 which are of concave cross-section, flanges 2a2, 2b2 are formed at these chamber bodies 2a1, 2b1, and disk-shaped plate-like members 2a3, 2b3 which cover the concavities of chamber bodies 2a1, 2b1 are formed in an integrated fashion with respect to these flanges 2a2, 2b2. As a result of which, the interiors of chamber bodies 2a1, 2b1 are partitioned by divider 6 and plate-like members 2a3, 2b3 to form a plurality of compartments. A plurality of through-holes 16, 17 which respectively communicate with the plurality of separation-membrane-equipped tubes 1 are located in disk-shaped plate-like members 2a3, 2b3.

Note that instead of providing plate-like members 2a3, 2b3 at flanges 2a2, 2b2, it is also possible that the plurality of compartments in chamber bodies 2a1, 2b1 are formed by divider 6 and fixed plate 7.

Provided at chamber 2a at the left side of module body 3 is fluid inlet 11 which communicates with one of the three compartments, and fluid outlet 12 which communicates with another one of the compartments. Mixed fluid entering thereinto by way of fluid inlet 11 might, for example, be feed liquid which should be separated and which contain ethanol and water; and mixed fluid exiting therefrom by way of fluid outlet 12 might, for example, be liquid containing a high concentration of ethanol. Fluid(s) which may be separated by separation-membrane-equipped tubes 1 include not only water, but may be any of various conventionally known fluids, such as, for example, hydrogen, carbon dioxide, and so forth.

Fluid permeating therethrough from the interior of separation-membrane-equipped tubes 1 to the exterior thereof, e.g., where this is water, the water would be discharged from discharge outlet 9 provided at housing 5. Discharge outlet 9 is not limited to being singular, it being possible for any number thereof to be present.

Note that whereas description was given in terms of an example in which chamber body 2a1 at the left side in FIG. 1 was provided with fluid inlet 11 and fluid outlet 12, it is also possible, for example, to provide chamber body 2a1 at the left side with fluid inlet 11, and to provide chamber body 2b1 at the right side with fluid outlet 12. For simplicity of construction and ease of manufacturing, both fluid inlet 11 and fluid outlet 12 may be provided at the same one of the chamber bodies 2a1, 2b1.

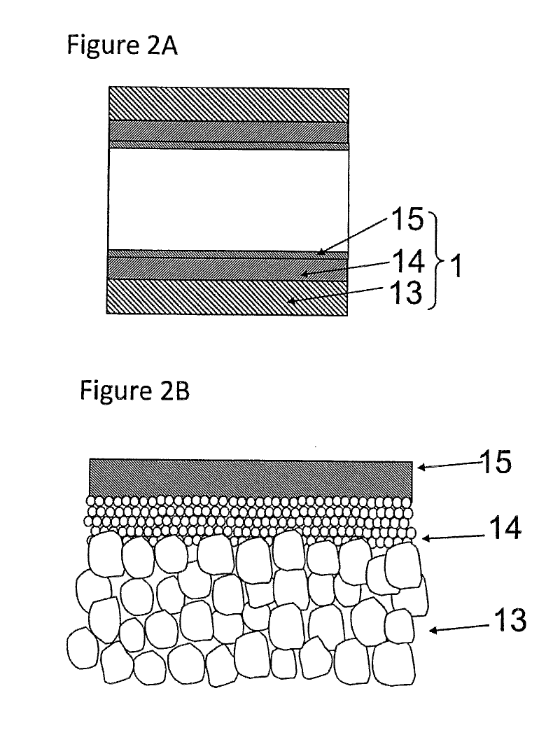

As shown in FIG. 2, the constitution of separation-membrane-equipped tube 1 is such that porous intermediate layer 14 is provided at the inside face of porous support tube 13, and separation membrane 15 is provided at the inside face of this intermediate layer 14. Support tube 13 might, for example, comprise ceramic material; intermediate layer 14 might, for example, comprise carbon particles; and separation membrane 15 might, for example, consist of glassy carbon. The structure of separation-membrane-equipped tube 1 is not limited hereto, it being possible, for example, to employ separation membranes other than glassy carbon.

In a separation membrane module constituted as described above, mixed fluid, for example, containing ethanol and water which serves as the feed liquid might, as indicated by the arrows in FIG. 1A, be guided from fluid inlet 11 to the interior of a compartment produced by partitioning by divider 6 of left-side chamber body 2a1, pass through the interior of separation-membrane-equipped tube 1a, be guided to the interior of a compartment produced by partitioning by divider 6 of right-side chamber body 2b1, pass through the interior of separation-membrane-equipped tube 1b which communicates with the interior of same compartment of chamber body 2b1, be guided to the interior of a compartment produced by partitioning by divider 6 of left-side chamber body 2a1, pass through the interior of separation-membrane-equipped tube 1c which communicates with the interior of same compartment of chamber body 2a1, be guided to the interior of a compartment produced by partitioning by divider 6 of right-side chamber body 2b1, pass through the interior of separation-membrane-equipped tube 1d which communicates with the interior of same compartment of chamber body 2b1, be guided to the interior of a compartment produced by partitioning by divider 6 of left-side chamber body 2a1, and exit therefrom by way of fluid outlet 12. FIGS. 1B and 1C also show how fluid flows within chamber bodies 2a1, 2b1.

FIG. 1B is a perspective view showing how this would appear when viewed from the left side of FIG. 1A, and FIG. 1C is a perspective view showing how this would appear when viewed from the right side of FIG. 1A.

In addition, while the fluid containing ethanol and water is passing through the interior of separation-membrane-equipped tubes 1 (separation-membrane-equipped tubes 1a, 1b, 1c, 1d may sometimes be referred to collectively as “separation-membrane-equipped tubes 1”), water permeates separation membrane 15 and is discharged from discharge outlet 9, and the fluid retentate which contains a high concentration of ethanol exits therefrom by way of fluid outlet 12.

Because the separation membrane module of an embodiment is such that divider 6 within chamber bodies 2a1, 2b1 cause fluid to sequentially flow in series fashion through the interiors of the four separation-membrane-equipped tubes 1—which is to say that flow of fluid proceeds in the order: separation-membrane-equipped tube 1a, separation-membrane-equipped tube 1b, separation-membrane-equipped tube 1c, separation-membrane-equipped tube 1d—this means that structure may be simpler, automation during manufacturing may be facilitated, and manufacturing may be made easier as compared with conventional situations in which U-shaped pipes are used to connect a plurality of separation-membrane-equipped tubes.

Furthermore, because it is possible by removing the bolts that join flanges 2a2, 2b2 and fixed plates 7 to disengage the series connection(s) that exists between/among separation-membrane-equipped tubes 1, this may facilitate replacement operations when separation-membrane-equipped tube(s) 1 become damaged or degraded, and also may make it possible to easily carry out operations for removal of scale that is deposited within separation-membrane-equipped tubes 1.

Furthermore, in the separation membrane module of an embodiment of the disclosure, by removing the bolts that join flanges 2a2, 2b2 and fixed plates 7, rotating chambers 2a, 2b, and tightening the bolts, it is possible to cause dividers 6 of chamber bodies 2a1, 2b1 to change the order in which fluid flows through the interiors of the plurality of separation-membrane-equipped tubes 1.

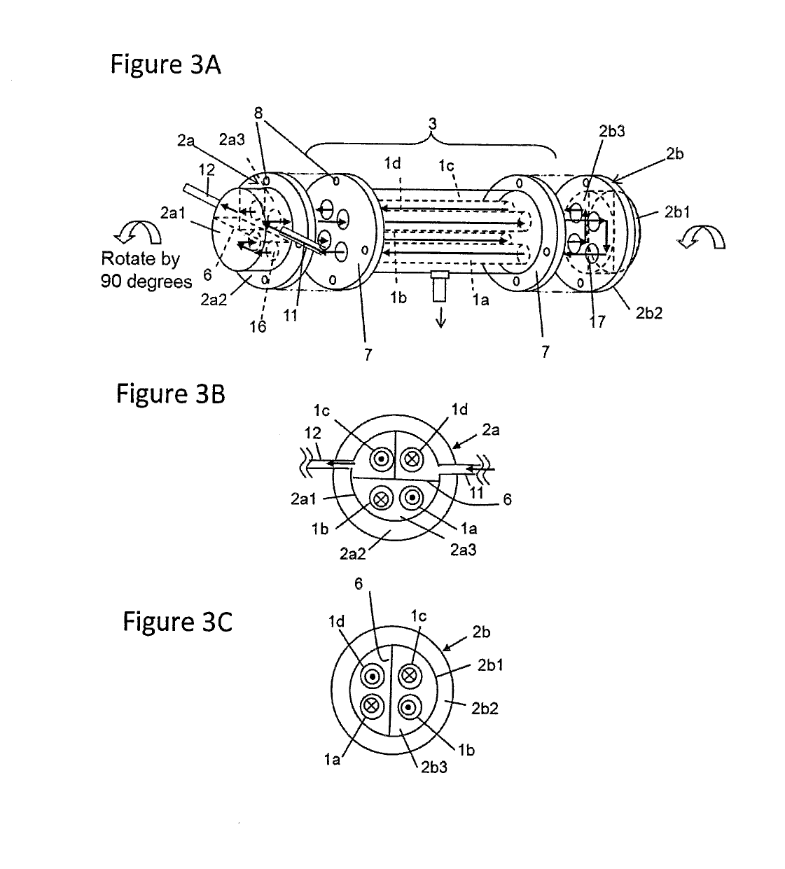

That is, FIG. 3 shows the situation that exists when chambers 2a, 2b are attached in such fashion that they are respectively rotated by 90 degrees with respect to fixed plates 7 of module body 3 relative to the situation that exists at FIG. 1. At this separation membrane module, fluid, for example, containing ethanol and water which serves as feed liquid might, as indicated by the arrows in FIG. 3A, be guided from fluid inlet 11 to the interior of a compartment produced by partitioning by divider 6 of left-side chamber body 2a1, pass through the interior of separation-membrane-equipped tube 1d, be guided to the interior of a compartment produced by partitioning by divider 6 of right-side chamber body 2b1, pass through the interior of separation-membrane-equipped tube 1a which communicates with the interior of same compartment of chamber body 2b1, be guided to the interior of a compartment produced by partitioning by divider 6 of left-side chamber body 2a1, pass through the interior of separation-membrane-equipped tube 1b which communicates with the interior of same compartment of chamber body 2a1, be guided to the interior of a compartment produced by partitioning by divider 6 of right-side chamber body 2b1, pass through the interior of separation-membrane-equipped tube 1c which communicates with the interior of same compartment of chamber body 2b1, be guided to the interior of a compartment produced by partitioning by divider 6 of left-side chamber body 2a1, and exit therefrom by way of fluid outlet 12. FIGS. 3B and 3C also show how fluid flows within chamber bodies 2a1, 2b1.

Accordingly, whereas in the separation membrane module of FIG. 1 fluid flowed in series fashion in the order separation-membrane-equipped tube 1a, separation-membrane-equipped tube 1b, separation-membrane-equipped tube 1c, separation-membrane-equipped tube 1d, in the separation membrane module of FIG. 3, rotation of respective chambers 2a, 2b by 90 degrees makes it possible to cause fluid to flow in series fashion in the order separation-membrane-equipped tube 1d, separation-membrane-equipped tube 1a, separation-membrane-equipped tube 1b, separation-membrane-equipped tube 1c, such that it is possible to change the order of flow through the interiors of separation-membrane-equipped tubes 1; and so consequently, by respectively rotating chambers 2a, 2b after a given amount of time has passed following commencement of fluid separation, it is possible to change the order in which fluid flows through the interiors of separation-membrane-equipped tubes 1, making it possible to equalize the degree of degradation of each separation-membrane-equipped tube 1, as a result of which life of separation-membrane-equipped tubes 1 may be able to be extended, and life of the separation membrane module may be able to be extended.

Note that whereas in the foregoing embodiment chambers 2a, 2b were rotated after a given amount of time had passed following commencement of fluid separation, it is also possible, for example, to rotate chambers 2a, 2b after a given amount of material has been separated by the separation membrane module.

Furthermore, sensor(s) (not shown) might be arranged at fluid outlet 12, and concentration(s) of constituent(s) present within mixed fluid passing through the interior of separation-membrane-equipped tubes 1 might be measured. Chambers 2a, 2b may be rotated based on such measured concentration(s); e.g., when concentration of a separated constituent that has permeated the separation membrane(s) exceeds predetermined value. Note that constituent(s) measured by sensor(s) may be constituent(s) that permeate and are separated by separation membrane(s), and/or may be constituent(s) that do not permeate separation membrane(s) but become concentrated within mixed fluid.

Moreover, sensor(s) that measure concentration(s) of constituent(s) present within mixed fluid may be arranged at interior(s) of compartments(s) in chamber body 2a1 and 2b1. By arranging sensor(s) within at least one of the compartments in chamber body 2a1 and 2b1, and detecting variation in concentration(s) of constituent(s) present within mixed fluid, since, in the event that an abnormality occurs with respect to concentration(s) of constituent(s) present within mixed fluid, the damaged or degraded separation-membrane-equipped tube(s) 1 is(are) located upstream from the sensor(s) at which the abnormality was detected, it may be possible to easily narrow down the location(s) thereof.

While FIG. 3 shows the situation that exists when chambers 2a, 2b are attached in such fashion that they are respectively rotated by 90 degrees from the situation that existed at FIG. 1, it is of course possible to rotate these by 180 degrees or 270 degrees. In such case also, it will be possible to change the order in which fluid flows through the interiors of the separation-membrane-equipped tubes 1.

That is, much of the water that is contained within feed liquid (mixed fluid) supplied from fluid inlet 11 is separated at separation-membrane-equipped tube(s) 1 near fluid inlet 11, the water content within the mixed fluid which flows through the interiors of the separation-membrane-equipped tube(s) 1 decreasing as it gets closer to fluid outlet 12. That is, the closer the separation-membrane-equipped tube 1 is to fluid inlet 11, the greater will be the tendency to become degraded due to the influence of water thereon, but because by respectively rotating chambers 2a, 2b it is possible to change the order of flow through the interiors of separation-membrane-equipped tubes 1, it is possible to equalize the degree of degradation of each separation-membrane-equipped tube 1, as a result of which life of separation-membrane-equipped tubes 1 can be extended, and life of the separation membrane module can be extended.

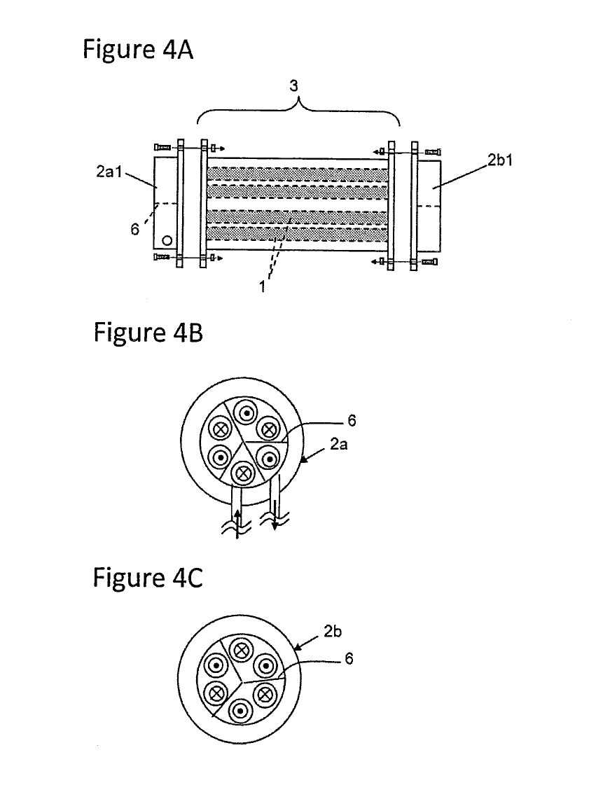

FIG. 4 shows a separation membrane module in accordance with an embodiment, there being six separation-membrane-equipped tubes 1 in an embodiment. Divider 6 provided within chamber body 2a1 at the left side of module body 3 divides the interior of chamber body 2a1 into four compartments, and divider 6 provided within chamber body 2b1 at the right side of module body 3 divides the interior of chamber body 2b1 into three compartments, separation-membrane-equipped tubes 1 communicating with the respective compartments.

Because with such a separation membrane module it is also the case that dividers 6 within chamber bodies 2a1, 2b1 cause fluid to flow in series fashion within the six separation-membrane-equipped tubes 1, this means that structure may be simpler, automation during manufacturing may be facilitated, and manufacturing may be made easier as compared with conventional situations in which U-shaped pipes are used to connect a plurality of separation-membrane-equipped tubes; and furthermore, rotation of chambers 2a, 2b makes it possible to cause dividers 6 of chamber bodies 2a1, 2b1 to change the order in which fluid flows through the interiors of the plurality of separation-membrane-equipped tubes 1, making it possible to equalize the degree of degradation of each separation-membrane-equipped tube 1, as a result of which life of separation-membrane-equipped tubes 1 can be extended, and life of the separation membrane module can be extended.

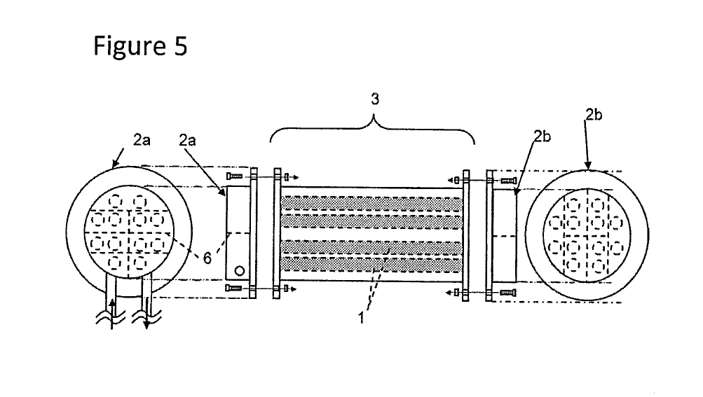

FIG. 5 shows a separation membrane module in accordance with an embodiment, there being twelve separation-membrane-equipped tubes 1 in an embodiment. Divider 6 provided within chamber body 2a1 at the left side of module body 3 divides the interior of chamber body 2a1 into seven compartments, and divider 6 provided within chamber body 2b1 at the right side of module body 3 divides the interior of chamber body 2b1 into six compartments, separation-membrane-equipped tubes 1 communicating with the respective compartments.

With such a separation membrane module it is also the case that manufacturing may be made easy; and furthermore, rotation of chambers 2a, 2b makes it possible to cause dividers 6 of chamber bodies 2a1, 2b1 to change the order in which fluid flows through the interiors of the plurality of separation-membrane-equipped tubes 1, making it possible to equalize the degree of degradation of each separation-membrane-equipped tube 1.

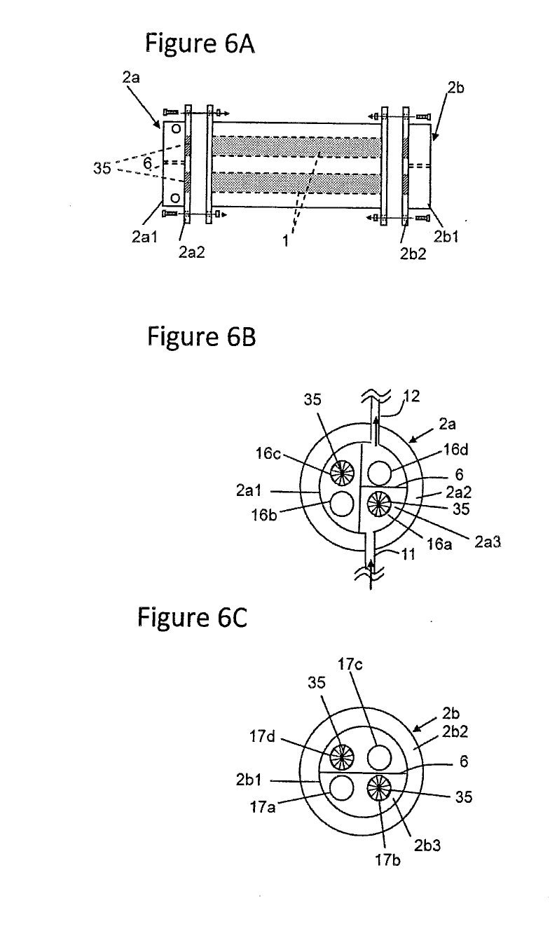

FIG. 6 shows a separation membrane module in accordance with an embodiment comprising swirling-flow inducers, swirling-flow inducers 35 which induce swirling flow in fluid within separation-membrane-equipped tubes 1 being provided in the vicinity of openings at upstream sides of separation-membrane-equipped tubes 1, which is to say in the vicinity of openings at fluid inlet sides of separation-membrane-equipped tubes 1, which is again to say in the vicinity of fluid entrances of separation-membrane-equipped tubes 1. These swirling-flow inducers 35 are provided at through-holes 16, 17 in plate-like members 2a3, 2b3 formed in an integrated fashion with respect to flanges 2a2, 2b2.

That is, swirling-flow inducers 35 are provided at through-hole 16a in plate-like member 2a3 arranged at the upstream side of separation-membrane-equipped tube 1a, at through-hole 16c in plate-like member 2a3 arranged at the upstream side of separation-membrane-equipped tube 1c, at through-hole 17b in plate-like member 2b3 arranged at the upstream side of separation-membrane-equipped tube 1b, and at through-hole 17d in plate-like member 2b3 arranged at the upstream side of separation-membrane-equipped tube 1d. Conversely, swirling-flow inducers 35 are not provided at through-hole 17a in plate-like member 2b3 arranged at the downstream side of separation-membrane-equipped tube 1a, nor at through-hole 17c in plate-like member 2b3 arranged at the downstream side of separation-membrane-equipped tube 1c, nor at through-hole 16b in plate-like member 2a3 arranged at the downstream side of separation-membrane-equipped tube 1b, nor at through-hole 16d in plate-like member 2a3 arranged at the downstream side of separation-membrane-equipped tube 1d.

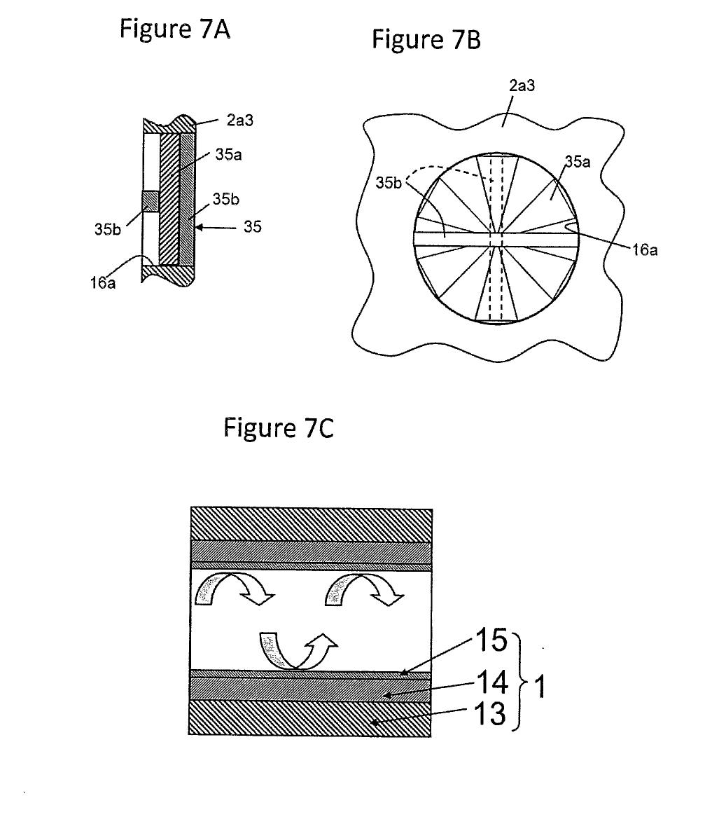

Taking the example of the swirling-flow inducer 35 provided at through-hole 16a in plate-like member 2a3, the structure of swirling-flow inducers 35 will be described with reference to FIG. 7A.

As shown in FIG. 7B, swirling-flow inducer 35 is constituted so as to be equipped with propeller 35a which is constituted such that a plurality of vanes are provided at a rotatable shaft, and with two support members 35b which are for rotatably attaching propeller 35a to the wall of through-hole 16a in plate-like member 2a3. The two support members 35b are combined in cruciform fashion within through-hole 16a in plate-like member 2a3, and are moreover combined in such fashion as to straddle the rotatable shaft of propeller 35a, the ends of the two support members 35b being attached to the wall of through-hole 16a in plate-like member 2a3. The two support members 35b may be arranged to mutually perpendicular within through-hole 16a in plate-like member 2a3. The two support members 35b may be arranged so that rotatably attaching propeller 35a may be inserted between them.

These swirling-flow inducers 35 are provided at through-holes 16, 17 at entrance sides where fluid flows into separation-membrane-equipped tubes 1 (through-holes 16a, 16b, 16c, 16d may sometimes be referred to collectively as “through-holes 16”; through-holes 17a, 17b, 17c, 17d may sometimes be referred to collectively as “through-holes 17”), swirling flow being induced, as shown in FIG. 7C, when fluid flows into separation-membrane-equipped tubes 1. Accordingly, of the through-holes 16, 17 in plate-like members 2a3, 2b3, those through-holes 16, 17 at exit sides where fluid flows out of separation-membrane-equipped tubes 1 are not provided with swirling-flow inducer 35.

Moreover, with conventional separation membrane modules, because fluid tends to flow through the central region of the separation-membrane-equipped tube 1, there is less tendency for fresh fluid to flow in the vicinity of the separation membrane 15 formed at the inside of the separation-membrane-equipped tube 1; and furthermore, because, in the vicinity of separation membrane 15 at the inside face of separation-membrane-equipped tube 1, as water permeates therethrough and escapes therefrom, this causes ethanol concentration to increase so that it is greater there than in the central region of separation-membrane-equipped tube 1, meaning that there is less tendency for fresh fluid to flow there, this tends to cause reduced separation performance.

In contradistinction hereto, in an embodiment, because swirling-flow inducers 35 which induce swirling flow in fluid within separation-membrane-equipped tubes 1 are provided at through-holes 16, 17 in plate-like members 2a3, 2b3 at upstream sides of separation-membrane-equipped tubes 1, this may make it possible, without the need to provide swirling-flow inducer(s) 35 directly at or in the vicinity of separation membrane(s) 15 at inside face(s) of separation-membrane-equipped tube(s) 1, to force fluid, which would otherwise tend to pass through central region(s) within separation-membrane-equipped tube(s) 1, to be supplied to the vicinity of separation membrane(s) 15 at inside face(s) of separation-membrane-equipped tube(s) 1, making it possible to adequately supply fresh fluid serving as feed liquid to the vicinity of separation membrane(s) 15, and to improve separation performance, without causing damage to separation membrane(s) 15.

Note that, with regard to swirling-flow inducer 35, propeller 35a may rotate through application of motive force; however, even where propeller 35a is secured to support member(s) 35b such that it is prevented from rotating, it will still be possible to induce swirling flow to some extent. Moreover, besides propeller 35a, it may be possible to use conventionally known swirling-flow inducer(s).

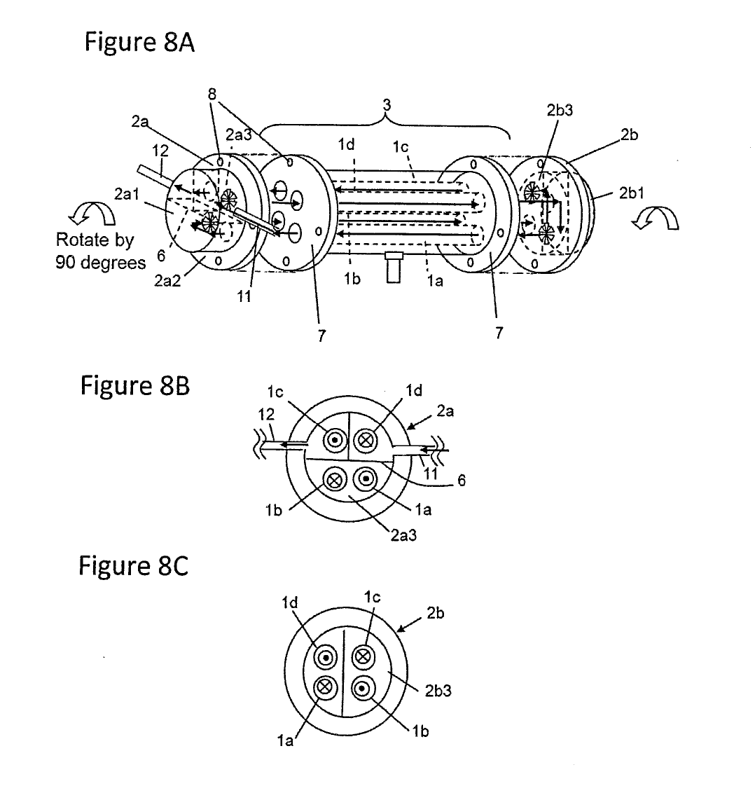

As shown in FIG. 8, because the embodiment is such that dividers 6 within chamber bodies 2a1, 2b1 cause fluid to flow in series fashion within the four separation-membrane-equipped tubes 1, this means that structure may be simpler, automation during manufacturing may be facilitated, and manufacturing may be made easier as compared with conventional situations in which U-shaped pipes are used to connect a plurality of separation-membrane-equipped tubes; and furthermore, rotation of chambers 2a, 2b makes it possible to cause dividers 6 of chamber bodies 2a1, 2b1 to change the order in which fluid flows through the interiors of the plurality of separation-membrane-equipped tubes 1, making it possible to equalize the degree of degradation of each separation-membrane-equipped tube 1, as a result of which life of separation-membrane-equipped tubes 1 can be extended, and life of the separation membrane module can be extended.

Moreover, because swirling-flow inducers 35 are provided at through-holes 16, 17 in plate-like members 2a3, 2b3, the relationship between the locations at which fluid inlet 11 and fluid outlet 12 are attached to chamber bodies 2a1, 2b1 and the locations at which swirling-flow inducers 35 are provided does not change, and so it is possible to cause swirling-flow inducers 35 to always be located at upstream sides of respective separation-membrane-equipped tubes 1 regardless of whether chambers 2a, 2b have been rotated.

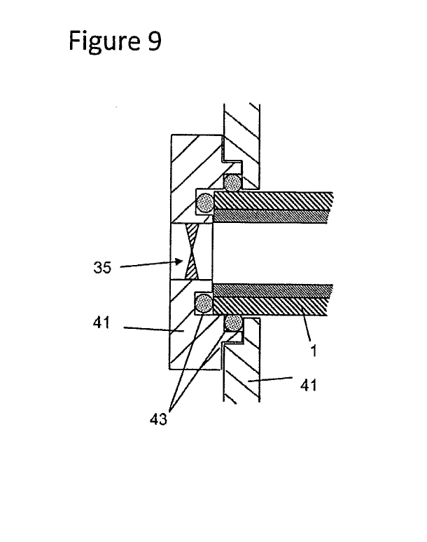

Note that instead of providing plate-like members 2a3, 2b3 in integral with respect to flanges 2a2, 2b2, it is also possible form the plurality of compartments by using dividers 6 and fixed plates 7 to partition the interiors of chamber bodies 2a1, 2b1. In such case, as shown in FIG. 9, by using screws or the like to attach fixed member(s) 41, to which swirling-flow inducer 35 has been attached, to fixed plate 7, which is located at the opening of separation-membrane-equipped tube 1, it will be possible to cause swirling-flow inducer 35 to be provided in the vicinity of the entrance at the upstream side of fixed plate 7. In FIG. 9, reference numeral 43 is annular seal material that prevents leakage of fluid from separation-membrane-equipped tube(s) 1.

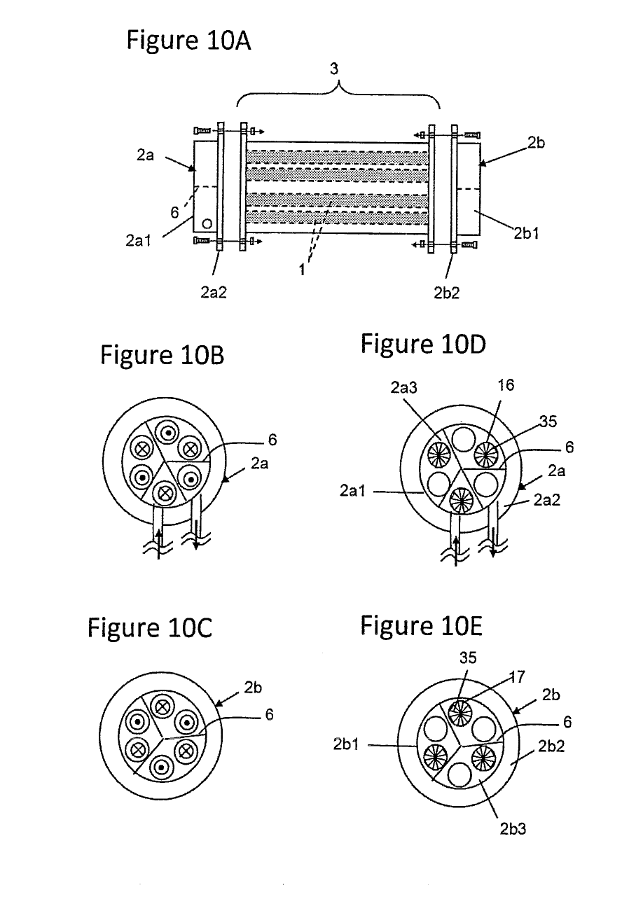

FIG. 10 shows a separation membrane module in accordance with an embodiment, there being six separation-membrane-equipped tubes 1 in an embodiment. Divider 6 provided within chamber body 2a1 at the left side of module body 3 divides the interior of chamber body 2a1 into four compartments as shown in FIG. 10B, and divider 6 provided within chamber body 2b1 at the right side of module body 3 divides the interior of chamber body 2b1 into three compartments as shown in FIG. 10C, separation-membrane-equipped tubes 1 communicating with the respective compartments.

In addition, as shown in FIGS. 10D and 10E, swirling-flow inducers 35 which induce swirling flow in fluid within separation-membrane-equipped tubes 1 are, as was the case at FIG. 6, provided at through-holes 16, 17 at upstream sides of separation-membrane-equipped tubes 1.

Because with such a separation membrane module it is also the case that dividers 6 within chamber bodies 2a1, 2b1 cause fluid to flow in series fashion within the six separation-membrane-equipped tubes 1, this means that structure may be simpler, automation during manufacturing may facilitated, and manufacturing may be made easier as compared with conventional situations in which U-shaped pipes are used to connect a plurality of separation-membrane-equipped tubes; and furthermore, rotation of chambers 2a, 2b makes it possible to cause dividers 6 of chamber bodies 2a1, 2b1 to change the order in which fluid flows through the interiors of the plurality of separation-membrane-equipped tubes 1, making it possible to equalize the degree of degradation of each separation-membrane-equipped tube 1, as a result of which life of separation-membrane-equipped tubes 1 can be extended, and life of the separation membrane module can be extended.

Moreover, swirling-flow inducers 35 at upstream sides of separation-membrane-equipped tubes 1 make it possible to adequately supply fresh fluid serving as feed liquid to the vicinity of separation membrane(s) 15, and to improve separation performance, without causing damage to separation membrane(s) 15. Note that it is of course possible to provide swirling-flow inducers 35 in the context of separation membrane modules having twelve separation-membrane-equipped tubes 1 as shown in FIG. 5, or in the context of separation membrane modules having more than twelve separation-membrane-equipped tubes 1.

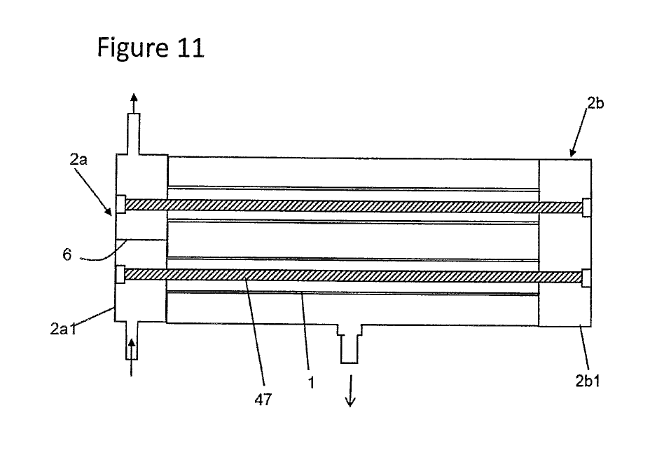

FIG. 11 shows a separation membrane module in accordance with an embodiment having rod heaters 47 within separation-membrane-equipped tubes 1, this separation membrane module being such that disk-shaped plate-like members 2a3, 2b3 are formed in an integrated fashion with respect to flanges 2a2, 2b2, through-holes 16, 17 being formed in these plate-like members 2a3, 2b3 at locations corresponding to the openings of separation-membrane-equipped tubes 1. In addition, rod heaters 47 are inserted within separation-membrane-equipped tubes 1, the two ends thereof being attached to inside faces of chamber bodies 2a1, 2b1, with heating occurred as a result of application of electric current to rod heaters 47 from the exterior of chamber bodies 2a1, 2b1.

In conventional separation membrane modules, the fact that fluid passes through long flow passage(s) produced by connection in series fashion of separation-membrane-equipped tubes 1 causes loss of heat during permeation of separation membranes due to latent heat accompanying vaporization of that permeate, and causes reduction in fluid temperature at downstream locations, which tends to decrease separation performance; however, in an embodiment, because rod heaters 47 are arranged within separation-membrane-equipped tubes 1, it is possible to increase fluid temperature where it might otherwise tend to decrease, and to improve separation performance.

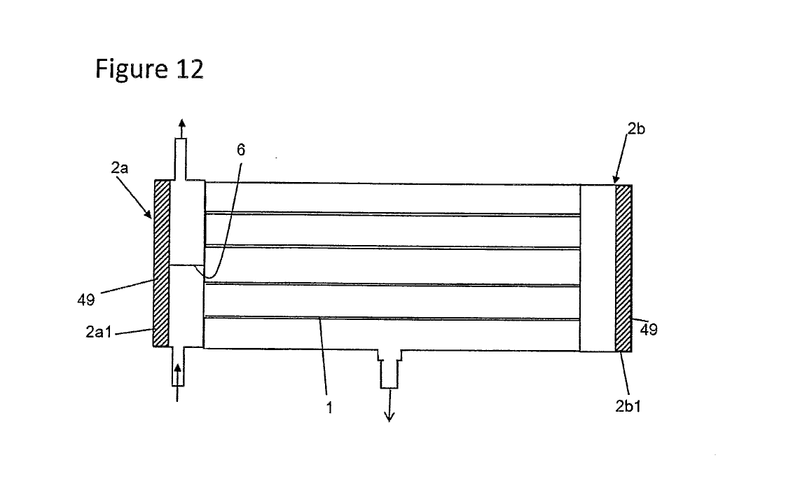

Note that where rod heaters 47 cannot be inserted within separation-membrane-equipped tubes 1 because of small inside diameter or the like at separation-membrane-equipped tubes 1, it is also possible as shown in FIG. 12 to provide heating devices 49 at inside faces of chamber bodies 2a1, 2b1. In such case, it will also be possible to rotate chambers 2a, 2b.

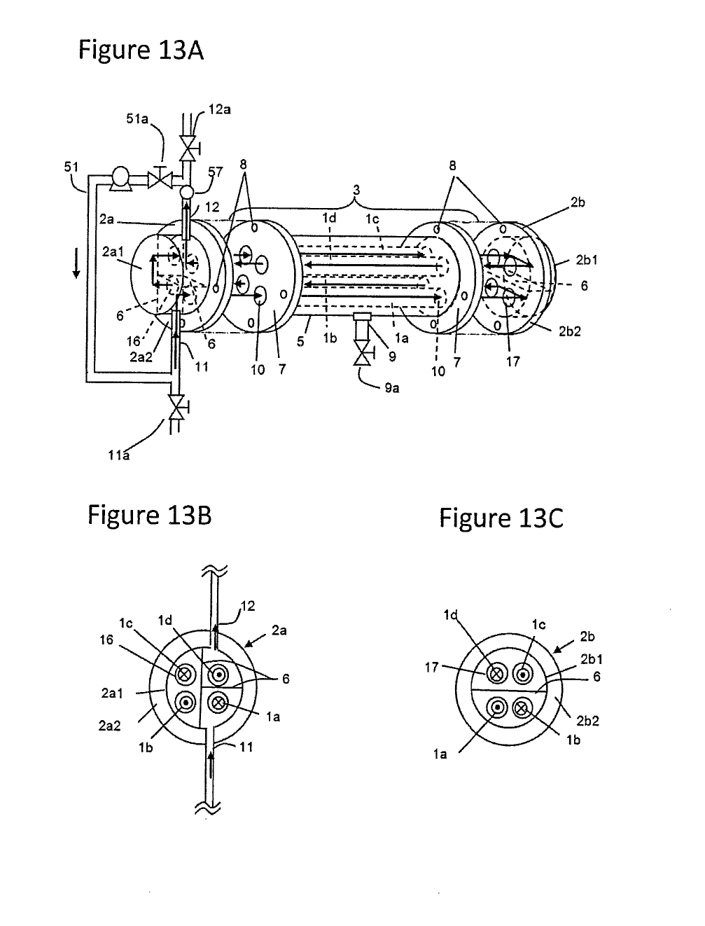

In FIG. 13, fluid inlet 11 and fluid outlet 12 of chamber body 2a1 are respectively provided with fluid inlet shutoff valve 11a and fluid outlet shutoff valve 12a; furthermore, circulation passage 51, which is opened and closed by circulation passage shutoff valve 51a, is arranged so as to be connected, between fluid inlet shutoff valve 11a and fluid outlet shutoff valve 12a, to chamber body 2a1. This makes it possible to close fluid inlet shutoff valve 11a and fluid outlet shutoff valve 12a, and while in this state, open circulation passage shutoff valve 51a, causing fluid from fluid outlet 12 to flow to fluid inlet 11 and to pass again through separation-membrane-equipped tubes 1, as a result of which batch processing can be occurred.

Note that a pump or the like may be arranged at circulation passage 51 and used as necessary to cause fluid from fluid outlet 12 to flow to fluid inlet 11 through circulation passage 51. Furthermore, sensor(s) 57 might, for example, be arranged at compartments(s) connected to fluid outlet 12, and concentration(s) of constituent(s) present within mixed fluid passing through interior(s) of separation-membrane-equipped tube(s) 1 might be measured, so that whether circulation passage 51 should be used and batch processing carried out may be determined based on such measured concentration(s).

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A separation membrane module comprising:
a body comprising:
a first fixed plate and a second fixed plate; and
a plurality of tubes arranged with prescribed spacing, each tube comprising a separation membrane therein, wherein a first end of the tubes are attached to the first fixed plate, and a second end of the tubes are attached to the second fixed plate;
a first chamber on the first fixed plate at an opposite side where the tubes are attached, comprising a plurality of rooms divided by at least one divider; and
a second chamber on the second fixed plate at an opposite side where the tubes are attached, comprising a plurality of rooms divided by at least one divider;
wherein the tubes are connected in series in terms of fluid path.

2. The separation membrane module according to claim 1, wherein the first and second chambers further respectively comprise a chamber body and flange which is attached to the chamber body and which is secured to one of the first fixed plate and the second fixed plate; and
wherein the dividers of the rooms are connected to inner wall of the chamber body, and
wherein the first and second chambers are rotatably connected to the first and second fixed plates, respectively.

3. The separation membrane module according to claim 1, further comprising:
a sensor measuring concentration of a chemical in a fluid flowing within the tubes.

4. The separation membrane module according to claim 3, wherein the sensor is arranged at the inner of at least one of the plurality of rooms.

5. The separation membrane module according to claim 1, further comprising:
a swirling-flow inducer that is provided at a location which is upstream of at least one of the tubes induces swirling flow in a fluid within the tubes.

6. The separation membrane module according to claim 1, wherein the first chamber and the second chamber respectively comprise a chamber body, a flange which is attached to the chamber body and which is secured to at least one of the first fixed plate and the second fixed plate, and a plate-like member which is formed in an integrated fashion with respect to the flange and which cover openings of the chamber body; and
wherein the plate-like member comprises:
a plurality of through-holes which respectively communicate with the tubes; and
a swirling-flow inducer which is provided at least one of the through-holes and which induces swirling flow in a fluid within the tubes.

7. The separation membrane module according to claims 1, further comprising:
a fluid inlet through which a fluid flows into the first chamber;
a fluid outlet through which the fluid flowing within the separation-membrane-equipped tubes flows out of the first chamber,
on-off valves respectively provided at the fluid inlet and the fluid outlet; and
a circulation passage that causes the fluid flowing out of the fluid outlet to be returned to the fluid inlet when the on-off valves are in their closed states.

8. A fluid separation method for a separation membrane module, the method comprising:
repeatedly carrying out a first operation in which mixed fluid containing two or more types of fluid that flows into one of rooms within one of chambers flows within one of tubes, a second operation in which the mixed fluid flowing within one of the tubes flows into one of the rooms within another chamber, and a third operation in which the mixed fluid flowing within one of the rooms in the another chamber flows into another of the tubes by way of one of the rooms within the another chamber;
flowing the mixed fluid sequentially through interiors of the plurality of tubes;
passing at least one type of fluid comprised in the mixed fluid within the tubes through the separation membranes;
flowing another fluid comprised in the mixed fluid through interiors of the tubes; and
separating the mixed fluid into at least two fluids.

9. The fluid separation method of claim 8, wherein the mixed fluid comprises at least water and ethanol.

10. The fluid separation method of claim 8, further comprising:
rotatably securing the chambers to the fixed plates of a body;
rotating the chambers after a prescribed quantity of the mixed fluid has flowed within the tubes, or after passage of a prescribed time since commencement of the mixed fluid separation; and
changing an order in which the mixed fluid sequentially flows through interiors of tubes by rotating the chambers.

11. The fluid separation method of claim 8, further comprising:
measuring concentration of a chemical in the mixed fluid flowing within the tubes;
rotatably securing the chambers to the fixed plates of the body;
rotating the chambers based on concentration of a chemical in the mixed fluid; and
changing an order in which the mixed fluid sequentially flows through interiors of the plurality of tubes by rotating the chambers.
